(19) United States
(12) Patent Application Publication
(10) Pub. No.: US 2015/0047872 A1
(43) Pub. Date: Feb. 19, 2015

(54) INSULATING LAYER-COVERED ELECTRIC WIRE

(71) Applicant: NITTO DENKO CORPORATION, Ibaraki-shi, Osaka (JP)

(72) Inventor: Masaaki Mori, Osaka (JP)

(21) Appl. No.: 14/348,986

(22) PCT Filed: Oct. 10, 2012
(86) PCT No.: PCT/JP2012/006500

§ 371 Date: Apr. 1, 2014

(30) Foreign Application Priority Data
Nov. 7, 2011 (JP) 2011-243718

(51) Int. Cl. H01B 7/02; H01B 19/00; H01B 3/30

(52) U.S. Cl. CPC H01B 7/0241; H01B 3/30; H01B 19/00
USPC 174/110 PM

(57) ABSTRACT

The present invention provides a covered electric wire including an insulating layer made of a porous polytetrafluoroethylene membrane and having both good electrical properties and good mechanical properties. The present invention is a covered electric wire including a conductor wire and an insulating layer covering the conductor wire. This insulating layer is made of a porous polytetrafluoroethylene membrane showing an endothermic peak in a temperature range of 327° C. or higher and 335° C. or lower but not showing an endothermic peak in a temperature range of higher than 335° C. and 380° C. or lower, as measured by differential scanning calorimetry at a heating rate of 10° C./min.

### TECHNICAL FIELD

The present invention relates to an electric wire in which a conductor wire is covered with an insulating layer made of a porous polytetrafluoroethylene (PTFE) membrane.

### BACKGROUND ART

With recent increasing demand for wider band communication cables, development of lower-loss communication cables has become a very important technical subject.

In response to this need, in a conventional insulating layer-covered electric wire in which a conductor wire is covered with an insulating layer and which is commonly used as a communication cable, the conductor wire is covered with a film made of a foamed resin such as foamed polyethylene, foamed polypropylene, or foamed polystyrene. This is because a foamed resin film, that is, a porous resin film has voids and thus has a low dielectric constant, which allows a reduction in the dielectric loss in the resulting insulating layer-covered electric wire.

Recently, in order to further reduce the dielectric loss in an insulating layer-covered electric wire, a porous PTFE membrane has increasingly been used as an insulating layer because it is a lower dielectric constant material (see, for example, Patent Literatures 1 and 2).

In order to further reduce the dielectric loss in a covered electric wire including an insulating layer made of such a porous PTFE membrane, it is desirable that the porous PTFE membrane have a higher porosity (void ratio). However, a covered electric wire including an insulating layer made of a conventional porous PTFE membrane has a problem of low mechanical strength. In the case of an insulating layer having low mechanical strength, pressure is applied in the thickness direction of the insulating layer due to its tension and lap, resulting in a decrease in the porosity. Therefore, the dielectric constant of the insulating layer increases as its porosity decreases, resulting in degradation in the electrical properties of the electric wire. Therefore, any covered electric wire including an insulating layer made of a conventional porous PTFE membrane cannot exhibit both electrical and mechanical properties good enough to meet the requirements.

### CITATION LIST

### Patent Literature

Patent Literature 1: JP 11(1999)-260161 A

Patent Literature 2: JP 2000-011764 A

### SUMMARY OF INVENTION

### Technical Problem

It is an object of the present invention to provide a covered electric wire including an insulating layer made of a porous PTFE membrane and having both good electrical properties and good mechanical properties.

### Solution to Problem

The present invention that has achieved the above object is a covered electric wire including: a conductor wire; and an insulating layer covering the conductor wire. In this electric wire, the insulating layer is made of a porous polytetrafluoroethylene membrane showing an endothermic peak in a temperature range of 327° C. or higher and 335° C. or lower but not showing an endothermic peak in a temperature range of higher than 335° C. and 380° C. or lower, as measured by differential scanning calorimetry at a heating rate of 10° C./min.

In the present invention, it is preferable that the porous polytetrafluoroethylene membrane show an endothermic peak in a temperature range of 327° C. or higher and lower than 332° C. but do not show an endothermic peak in a temperature range of 332° C. or higher and 380° C. or lower, as measured by differential scanning calorimetry at a heating rate of 10° C./min.

In the present invention, it is preferable that the porous polytetrafluoroethylene membrane be obtained by uniaxial stretching under sintering. It is particularly preferable that the porous polytetrafluoroethylene membrane be obtained by uniaxial stretching at a stretching ratio of 4 to 10 under sintering at 340° C. to 380° C. for 60 to 80 seconds.

The present invention is preferably a covered electric wire in which the insulating layer made of the porous polytetrafluoroethylene membrane is wound around the conductor wire. In this electric wire, the insulating layer may be formed of a single sheet of the porous polytetrafluoroethylene membrane.

### Advantageous Effects of Invention

According to the present invention, it is possible to provide a covered electric wire including an insulating layer made of a porous PTFE membrane and having both good electrical properties and good mechanical properties.

### DESCRIPTION OF EMBODIMENTS

PTFE is a crystalline polymer having a melting point of 327° C. In order to form PTFE into a porous membrane, heat and stress are applied to the PTFE by treatments such as heating and stretching. When the porous PTFE membrane is subjected to differential scanning calorimetry, it shows a phenomenon in which the endothermic peak shifts from 327° C. due to the thermal and mechanical histories during the production of the porous PTFE membrane. As a result of studies, the present inventor has found that in a covered electric wire including an insulating layer made of a conventional porous PTFE membrane, the porous PTFE membrane shows an endothermic peak at about 340° C. The present inventor has also found that when a porous polytetrafluoroethylene membrane showing an endothermic peak in a temperature range of 327° C. or higher and 335° C. or lower but not showing an endothermic peak in a temperature range of higher than 335° C. and 380° C. or lower is used as an insulating layer for a covered electric wire, the covered electric wire having both good electrical properties and good mechanical properties can be provided.

Any known conductor wire can be used as the conductor wire of the covered electric wire of the present invention. For example, metal wires such as copper, copper alloy, aluminum, aluminum alloy, tin-plated copper (alloy), and silver-plated copper (alloy) wires can be used.

As the insulating layer of the covered electric wire of the present invention, a porous PTFE membrane showing an endothermic peak in a temperature range of 327° C. or higher and 335° C. or lower but not showing an endothermic peak in a temperature range of higher than 335° C. and 380° C. or lower, as measured by differential scanning calorimetry at a heating rate of 10° C./min, is used. Preferably, the porous PTFE membrane shows an endothermic peak in a temperature range of 327° C. or higher and lower than 332° C. but does not show an endothermic peak in a temperature range of 332° C. or higher and 380° C. or lower, as measured by differential scanning calorimetry at a heating rate of 10° C./min. More preferably, the porous PTFE membrane shows an endothermic peak in a temperature range of 327° C. or higher and 331° C. or lower but does not show an endothermic peak in a temperature range of higher than 331° C. and 380° C. or lower. In the present invention, the phrase “a material shows an endothermic peak in a given temperature range” means that a peak top of the endothermic peak is located in the given temperature range.

The porosity of the porous PTFE membrane is not particularly limited, but it is preferably 60 to 80% in view of the dielectric constant thereof.

The tensile strength of the porous PTFE membrane is not particularly limited, but it is preferably 40 to 70 MPa. Preferably, the porous PTFE membrane has a deformation ratio of 40% or less when compressed under a pressure of 20 MPa.

The thickness of the porous PTFE membrane is not particularly limited, but it is preferably 50 to 200 μm.

Preferably, the porous PTFE membrane is obtained by uniaxial stretching under sintering.

The porous PTFE membrane having the above-described features can be obtained, for example, by adding a liquid lubricant to a PTFE fine powder and mixing them, forming the resulting mixture into a sheet without sintering it, removing the liquid lubricant, and then uniaxially stretching the resulting sheet at a stretching ratio of 4 to 10 while sintering the sheet at 340° C. to 380° C. for 60 to 80 seconds.

The covered electric wire of the present invention can be configured such that the insulating layer made of the above-described porous PTFE membrane is wound around the conductor wire. In the present invention, even if the insulating layer is formed of a single sheet of the above porous PTFE membrane, a covered electric wire having both good electrical properties and good mechanical properties can be obtained.

### EXAMPLES

Hereinafter, the present invention is described in detail with reference to Examples and Comparative Example, but the present invention is not limited to these examples.

### Example 1

25 parts by weight of hydrocarbon oil serving as a liquid lubricant (“ISOPAR M” (trade name), Esso Oil Co.) was mixed homogeneously with 100 parts by weight of PTFE fine powder (“POLYFLON F-104” (trade name), Daikin Industries, Ltd.), and the resulting mixture was preformed by compression under a pressure of 20 kg/cm². Next, the preformed mixture was extruded into a rod, and the rod was passed between a pair of metal pressure rolls. Thus, a long sheet with a thickness of 0.2 mm and a width of 150 mm was obtained. Next, this formed sheet was heated to 220° C. to remove the liquid lubricant. Next, this sheet was stretched longitudinally to 5 times its original length while sintering the sheet at 360° C. for 60 seconds. Thus, a porous PTFE membrane was obtained.

### Example 2

25 parts by weight of hydrocarbon oil serving as a liquid lubricant (“ISOPAR M” (trade name), Esso Oil Co.) was mixed homogeneously with 100 parts by weight of PTFE fine powder (“POLYFLON F-104” (trade name), Daikin Industries, Ltd.), and the resulting mixture was preformed by compression under a pressure of 20 kg/cm². Next, the preformed mixture was extruded into a rod, and the rod was passed between a pair of metal pressure rolls. Thus, a long sheet with a thickness of 0.2 mm and a width of 150 mm was obtained. Next, this formed sheet was heated to 220° C. to remove the liquid lubricant. Next, this sheet was stretched longitudinally to 10 times its original length while sintering the sheet at 360° C. for 80 seconds. Thus, a porous PTFE membrane was obtained.

### Comparative Example 1

25 parts by weight of hydrocarbon oil serving as a liquid lubricant (“ISOPAR M” (trade name), Esso Oil Co.) was mixed homogeneously with 100 parts by weight of PTFE fine powder (“POLYFLON F-104” (trade name), Daikin Industries, Ltd.), and the resulting mixture was preformed by compression under a pressure of 20 kg/cm². Next, the preformed mixture was extruded into a rod, and the rod was passed between a pair of metal pressure rolls. Thus, a long sheet with a thickness of 0.2 mm and a width of 150 mm was obtained. Next, this formed sheet was heated to 220° C. to remove the liquid lubricant. Next, this sheet was stretched longitudinally to 10 times its original length without sintering the sheet. Thus, a porous PTFE membrane was obtained.

The properties of the porous PTFE membranes obtained in Examples and Comparative Example were evaluated in the following manner. Table 1 shows the results.

[Differential Scanning Calorimetric Analysis]

A DSC curve was measured with a differential scanning calorimeter (“DSC 6200”, Seiko Instruments Inc.) in a temperature range of 50° C. to 400° C., at a heating rate of 10° C./min., and at a nitrogen flow rate of 100 mL/min. Thus, an endothermic peak temperature was obtained.

[Thickness Measurement]

The thickness of each porous PTFE membrane was measured with a 1/1000 mm dial gauge.

[Porosity]

The weight and thickness of each porous PTFE membrane were determined, and the porosity thereof was calculated using the specific gravity of PTFE, i.e., 2.18 g/cm³.

[Tensile Strength]

The tensile strength was measured using an autograph according to JIS K 7161.

[Deformation Ratio]

A load of 1 kPa was applied in the thickness direction at 25° C. using a thermomechanical analyzer (“TMA 4000SA”, equipped with a 5-mm diameter quartz probe, Bruker AXS Inc.), and the deformation ratio was calculated by the following equation:

Deformation ratio [%]=(Amount of deformation [mm] under a load of 1 kPa)/(Thickness [mm] before applying the load)×100

TABLE 1

| | Example 1 | Example 2 | Com. Example 1 |
|---|---|---|---|
| Endothermic peak | One at 330° C. | One at 329° C. | One at 345° C. |
| Thickness [μm] | 142 | 61 | 55 |
| Porosity [%] | 69.33 | 68.50 | 66.23 |
| Tensile strength | 51.5 | 51 | 14 |
| [MPa] | | | |
| Deformation ratio | 35.98 | 35.48 | 88.48 |
| [%] | | | |

Table 1 shows that the porous PTFE membranes of Examples 1 and 2 have higher tensile strengths and lower deformation ratios than the porous PTFE membrane of Comparative Example 1. Therefore, when the porous PTFE membrane (insulating layer) of Example 1 or 2 is used as an insulating layer, the porosity is less likely to decrease and thus an increase in the dielectric constant is suppressed. Thus, it can be seen that the present invention makes it possible to obtain a covered electric wire including an insulating layer made of a porous PTFE membrane and having both good electrical properties and good mechanical properties.

1. A covered electric wire comprising:
a conductor wire; and
an insulating layer covering the conductor wire, the insulating layer being made of a porous polytetrafluoroethylene membrane showing an endothermic peak in a temperature range of 327° C. or higher and 335° C. or lower but not showing an endothermic peak in a temperature range of higher than 335° C. and 380° C. or lower, as measured by differential scanning calorimetry at a heating rate of 10° C./min.

2. The covered electric wire according to claim 1, wherein the porous polytetrafluoroethylene membrane shows an endothermic peak in a temperature range of 327° C. or higher and lower than 332° C. but does not show an endothermic peak in a temperature range of 332° C. or higher and 380° C. or lower, as measured by differential scanning calorimetry at a heating rate of 10° C./min.

3. The covered electric wire according to claim 1, wherein the porous polytetrafluoroethylene membrane is obtained by uniaxial stretching under sintering.

4. The covered electric wire according to claim 3, wherein the porous polytetrafluoroethylene membrane is obtained by uniaxial stretching at a stretching ratio of 4 to 10 under sintering at 340° C. to 380° C. for 60 to 80 seconds.

5. The covered electric wire according to claim 1, wherein the insulating layer made of the porous polytetrafluoroethylene membrane is wound around the conductor wire.

6. The covered electric wire according to claim 5, wherein the insulating layer is formed of a single sheet of the porous polytetrafluoroethylene membrane.
